(19) United States
(12) Patent Application Publication
(10) Pub. No.: US 2012/0185362 A1
(43) Pub. Date: Jul. 19, 2012

(54) 3D Version of online nationalization and localization restaurant menu self-creation and post method for restaurant businesses

(75) Inventor: Qiuhang Richard Qian, Round Rock, TX (US)

(73) Assignee: Qiuhang Richard Qian, Round Rock, TX (US)

(21) Appl. No.: 12/931,508

(22) Filed: Feb. 3, 2011

Related U.S. Application Data
(60) Provisional application No. 61/432,379, filed on Jan. 13, 2011.

(51) Int. Cl. G06Q 30/00

(52) U.S. Cl. 705/27.1

(57) ABSTRACT

A revolutionary online nationalization and localization restaurant menu self creation and post method is invented. The users can check any menu with other service categories in any restaurant in any city, or metro area in the U.S. The web application intended for the restaurant business is developed by .net and java. Both .net and java are development languages. They contain logic rules, packages, procedures, and triggers. The business will go through different stages to finish designing and creating contents. The stages will include providing information, selecting level, choosing service categories, front store design, contents creation verification, and online payment etc. There are design tools, templates and different programs developed and provided for the business to complete different tasks at each stage. The business follows the procedures, steps and creates restaurant menu and other service contents.

Online nationalization and localization restaurant menu self-creation is invented for the restaurant business to create menu, other service categories and run promotions etc. online by themselves using the free tools provided.

Users log onto the internet and access to the website where a 3D virtual restaurant simulation displays for 5 seconds on the first page before it disappears. The first alphabetical chain restaurant with 3D image will be shown on the next page. New pages with different chain restaurant will keep popping up every 4 seconds if it is not clicked. If it is clicked, the menu will show. This is the restaurant's menu module at the national level.

There are blocks on the top of the page for the users to type a city, or select a metro area and a state to find a restaurant. The users can also find a restaurant by entering zip code.

After the restaurant search information is provided, the page with the restaurant(s) in the city or metro area will appear. New pages with different restaurant(s) will keep popping up every 4 seconds if it is not clicked. If it is clicked, the menu will show. This is the restaurant's menu module at the local level.

The menu consists of main menu with images and videos. The image can be enlarged to full screen so that it can be seen clearly. The video will show how the meal looks like or how it is cooked. There are other service items along with the menu in the restaurant such as happy hour, today's special, this week's special, chef's recommendation, customer's favorites, new on the menu, drinking wine, coupon, our chefs, how is our restaurant, suggestions and video tour. These items are designed for the business to select and create the contents online using the free tools. The business can also name his or her own service category.

Right next to the search blocks on the top of the pages (either at the national or local level), there are create account, login, food fan tabs and other two icons. Create account is for the business or the user to create an account. Login is for the business or the user to login the account to create and manage the contents and account. Food fan is a community designed for the business and the user to share dining and other related experiences. It includes modules such as my favorite meal, my favorite restaurant, family recipes, my restaurant experience, accumulating bonus, winning prizes, gift certificates, get cash, local club, cook my favorite meal, and radio blogs etc. Clicking the first icon will show the business' promotions at the national level, metro area level or the city level in the image or video format. Clicking the second icon will display all the restaurants at the national, metro area or the city level.

### BACKGROUND OF THE INVENTION

Many times a lot of people don't know where to go to eat. Many people go to the restaurants without knowing what exactly they want to eat or not 100% sure what they will eat. Even those people know what they want to eat, they might miss other good choices. Restaurant menu will provide a great tool for the users to check restaurants and menus so that they will know where they want to go and what they will exactly eat and drink. It will help people make the decision and reduce time on the menu in the restaurant.

It is estimated there are over 210,000 full service restaurants and 260,000 fast food restaurants in the U.S. in 2009. There are over 60 fast food chain companies and about the same number of full service restaurant companies in the U.S. Currently the restaurants can be found through internet search or yellow page directory. However limited information is provided about the restaurants exception the locations. The current invention will resolve the problem and provide more detailed information about the restaurants. The invention will not only create easy solutions for the restaurant business to introduce and market itself online but also will create an online community where both the business and the user can share their experience.

### TECHNICAL FIELD

The present invention relates to the website and computer server systems that are capable of running and support web application and programs. More particularly, the present invention relates to the systems that are capable of running web application and provide online self-menu creation and other solutions for the restaurant business.

### BRIEF DESCRIPTION OF THE DRAWINGS

FIG. 1 is a logic process flow diagram illustrating how technically the platform is created for the restaurant business to create menu and other contents online.

FIG. 2 is a logic process flow diagram illustrating how technically the platform is created for the user to create contents online.

### DETAILED DESCRIPTION OF EXEMPLARY EMBODIMENTS

The present invention provides the solutions for creating online restaurant menu and other contents for the business by using the developed procedures and tools. The business is required to have an account to create and manage the contents. The user has the option to create account. Once the account is created, all the information related to the account will be saved in the database files on the server. The business and the user can access to the account to create, modify, delete, pause, close, renew and check the status etc. The business and the user follow the steps that are developed to help them finish or manage the contents. The contents created or modified will be saved. Other changes associated with the account will also be saved in the database on the server. There are some programs that will automatically run to help the web application run smoothly on the server.

Although the preferred embodiment will be generally described in the context of programs and operating systems running on the servers, those skilled in the art will recognize that the present invention also can be implemented in conjunction with other program modules for other types of computers. Furthermore, those skilled in the art will recognize that the present invention may be implemented in different network environments.

For example, in a two-tier network, a user communicates directly with a server. This is also known as a client-server architecture. A client-server network is an architecture that involves user processes that request service from server processes. The user and server communicate over a network using a given protocol, which must be installed on both the user and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user).

In a complex network environment, different hardware platforms run different operating systems; multiple protocols are used on these platforms; variable syntax exist between the different but connected applications; run on different geographical locations in which the connected applications reside. It supports a large-scale distributed system. In a distributed computing environment, program modules may be physically located in different local and remote memory storage devices. Execution of the program modules many occur locally in a stand-alone manner or remotely in a user server manner. Examples of such distributed computing environments include local area networks of an office, enterprise-wide computer networks and the global internet.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network. The processes and operations performed by the computer include the manipulation of signals by a CPU or remote server and the maintenance of these signals within data structures resident in one or more of the remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as creating, adding, changing, modifying, saving, calculating, comparing, moving, receiving, determining, identifying, populating, loading, executing, etc. that are often associated with manual operations performed by a human operator. The operations described herein can be machine operations performed in conjunction with various input provided by a human operator or a user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory, such as ready-only memory.

Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art. Now referring to the figures:

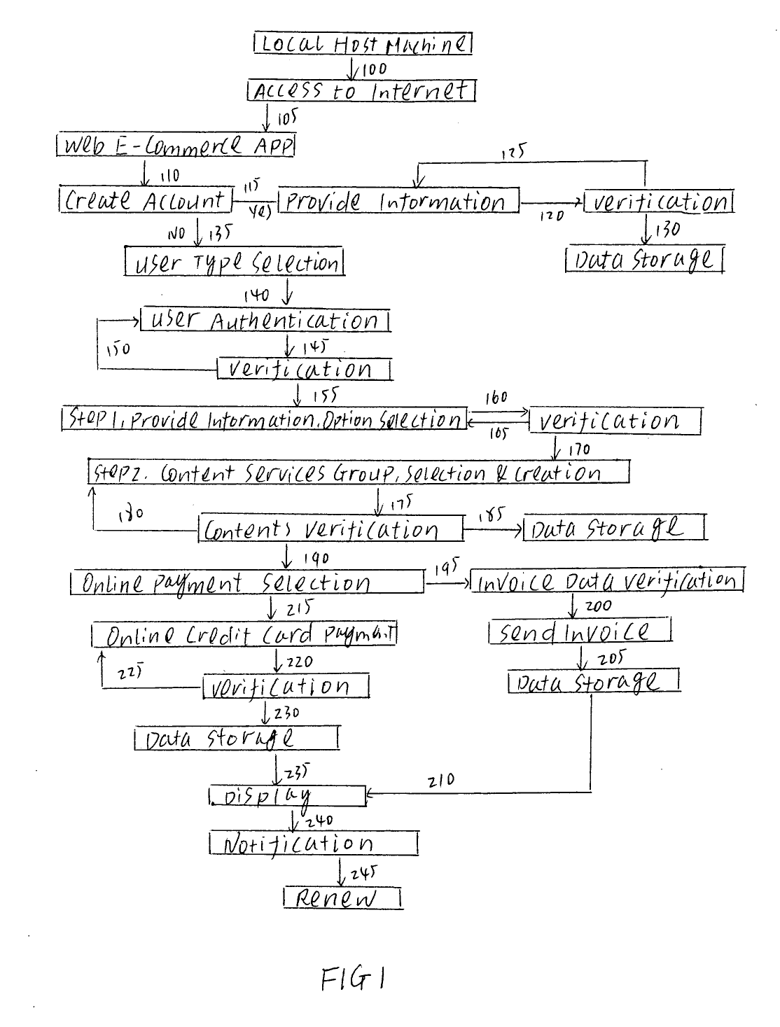

FIG. 1, the business logs into a local computer, connects to the internet and accesses to the web server (Step 100, 105). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the user (the business).

The web application displays graphic interface which is the first page of the website. The interface is made up of items. Items are used to present information from the database or to act as control. The web application is event-driven. An event occurs and the application responds to it. An event is either an interface event, which corresponds to a user action, or an internal processing event, which corresponds to a system action.

The business needs to establish an account in order to create and manage contents (Step 110). The account will be created after all the information is provided in the pre-designed form (Step 115). The data collected will be verified (Step 120). If the data are not valid, the process goes back to the step 115 until the valid data are provided (Step 125). If the data are valid, it will be saved in the database on the server (Step 130).

If the business has an account, he or she chooses user type when login (Step 135). The next step is authentication (Step 140). The business provides information to be verified (Step 145). During the verification, a java function is invoked. It provides a default verification routine to verify the validity of the data. The procedure returns the value TRUE for success and FALSE for failure. If the verification raises an exception, the data becomes invalid, an error is returned. The process will go back to the step 140 through the step 150. If the verification doesn't raise an exception, the process goes to the next steps which are information collection and options selection (Step 155).

There are sub-steps in the step 155. First, the business needs to provide restaurant name and address(es) and select the level(s). The level refers to either the national, metro area or local level. Second, the business needs to choose the options. The options include menu, happy hour, today's special, weekly special, chefs recommendation, new on the menu, name your own category, coupon, market promotion, our chefs, suggestions and video tour etc with the choices of providing image and video. Steps of providing information and choosing options are developed by .net or java. After these two sub-steps are done, they need to be verified (Step 160). During the verification, a java function is invoked. It provides a default verification routine to verify the validity of the data. The procedure returns the value TRUE for success and FALSE for failure. If the verification raises an exception, the data becomes invalid, an error is returned, the process goes back to the step 155 through the step 165 until all the data and picks are valid.

The next step is to create the contents according to the options that the business chooses (Step 170). There are sub-steps in the step 170. First is creating the front store. During the creation, the business can create a front store from the templates temporarily. The business needs to provide a real front store picture. The 3D front store will be developed with the help of internal 3D design engineers. Second is creating the menu. The business selects a menu from the templates and chooses background. After it is done, the business begins to create the menu. The menu consists of categories, meal names, prices, descriptions, images and videos etc. The business follows the steps to finish creating the contents; uploading the images and videos. Contents creation for happy hour, today's special, weekly special, chef's recommendation, new on the menu, drinking wine or others have almost the same creating process as creating the menu. Our Chefs is a service designed for introducing the chef(s) of the restaurant(s) if the business picks it. The business can introduce its chef(s) and upload the picture(s). Coupon is a service offering discount. When creating the coupon, the business picks a coupon from the templates and creates the coupon. Market promotion offers the business to promote its business at different levels within the website or outside the website. Suggestions is for restaurant(s) improvement purpose. How is our restaurant shows the satisfaction degree that the user towards the restaurant. These two services are designed for the users.

Video tour will display the restaurant. During the uploading, the server process parses the request and went back to look if and where the video is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server.

The templates, design tools and procedures for creating all the contents are developed by .net or java. .Net or Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. The tools include custom designed templates, background colors, patterns, canvas and editor etc.

After the sub-steps are done in the step 170, the contents need to be verified (Step 175). During the verification, a java function is invoked. It provides a default verification routine to verify the validity of the data. The procedure returns the value TRUE for success and FALSE for failure. If the verification raises an exception, the data becomes invalid, an error is returned, the process goes back to the step 170 through the step 180 until all the data are valid. If the data created are valid, they will be saved in the database on the server (Step 185). The database is a collection of data. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Next step is online payment selection (Step 190). If the business selects to pay by invoice, the automatic popping up invoice information needs to be verified (Step 195). After the verification, the invoice will be sent to the business (Step 200) and saved a copy in the database customer invoice module (Step 205). All the contents created will be displayed (Step 210).

If the business chooses to pay online using credit card, the business needs to provide the credit card information (Step 215). The credit card information provided needs to be verified (Step 220). During the verification, a java function is invoked. It provides a default verification routine to verify the validity of the data. The procedure returns the value TRUE for success and FALSE for failure. If the verification raises an exception, the data becomes invalid, an error is returned, and the process goes back to the step 215 through the step 225 until the data is valid. The credit card information will be saved and the contents will be displayed (Step 230 and 235). The business will be noticed when it comes to renew the service (Step 240). The process ends at either the business renewing, pausing or closing the service (Step 245).

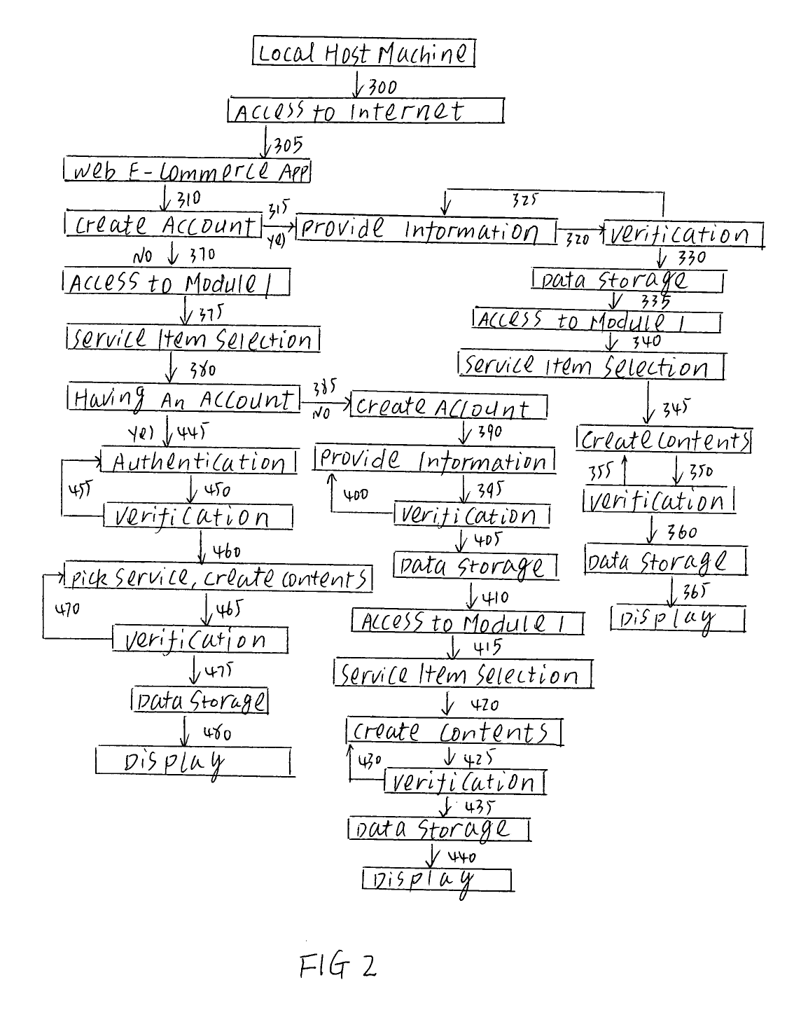

FIG. 2, the user connects to the Internet and accesses to the web server from local computer (Step 300, 305). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the user (the business).

The web application displays graphic interface which is the first page of the website. The interface is made up of items. Items are used to present information from the database or to act as control. The web application is event-driven. An event occurs and the application responds to it. An event is either an interface event, which corresponds to a user action, or an internal processing event, which corresponds to a system action.

The user has the option to create account after logging on the website (Step 310). If the user chooses to create an account, he or she needs to provide data in the pre-designed form (Step 315). The data collected need to be verified (Step 320). If the data are not valid, the process goes back to the step 315 until the data are valid through the step 325. If the data are valid, they will be saved in the database on the server (Step 330).

After the account is created, the user goes to module 1 (Step 335). Module 1 is the online community called Food Fan. The user can choose any service he or she wants. There are different services under Food Fan. These services include my favorite meal, my favorite restaurant, family recipes, my restaurant experience, accumulating bonus, win prizes, gift certificates, get some cash, local club, cook my favorite meal and radio blogs. The local club includes services such as my favorite meal, my favorite restaurant, my restaurant experience, dine together, recommend to others, and radio blog etc. The user can create contents for services.

These services are my favorite meal, my favorite restaurant, family recipes, my restaurant experience, cook my favorite meal, recommend to others, dine together, and radio blogs etc. The user picks a service and creates the content (Step 340 and 345). The design tools for creating the contents and process are developed by .net or java. .Net or Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. The tools include word processing editor etc.

After the contents are created, they need to be verified (Step 350). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 345 through the step 355 until the valid data are provided. If the contents are valid, they will be saved in the database on the server (Step 360 and 365). The database is a collection of data.

During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity. After the data are saved they will be displayed in the designated area (Step 365).

If the user chooses not to create account after logging into the website, he or she goes to Module 1 which is Food Fan (Step 370). When selecting a service to create the contents (Step 375), the user will be asked if he or she has an account (Step 380). If the user doesn't have one, he or she will be asked to create an account this time (Step 385). The user provides the data in the pre-designed form (Step 390). The data provided need to be verified (Step 395). If the data are not valid, the process will go back to the step 390 until the valid data are provided through the step 400. If the data are valid, they will be saved in the database (Step 405). After the account is created, the user goes back to the module 1 (Step 410) picks the service and create the contents. (Step 415 and 420). The contents created need to be verified (Step 425). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 420 until the valid content are provided through the step 430. If the created contents are valid, they will be saved in the database on the server (Step 435). The content results will be displayed (Step 440).

If the user has already had an account, the next step is authentication when logging the account after the user accesses to the website (Step 445). During the authentication, a java function is invoked. It provides a default verification routine to verify the validity of the data (Step 450). The procedure returns the value TRUE for success and FALSE for failure. If the verification raises an exception, the data becomes invalid, an error is returned. The process goes back to the step 440 until the valid data are provided through the step 455. If the procedure doesn't raise an exception, the user picks a service and creates the contents (Step 460). The contents created need to be verified (Step 465). If they are not valid, the process goes back to the step 460 until the valid data are provided through the step 470. If the contents created are valid, they will be saved in the database on the server and displayed in the designated area (Step 475 and 480).

1. 3D Version of Online Nationalization and Localization Restaurant Menu Self-Creation and Post Method for the Restaurant Business
